(19) United States
(12) Patent Application Publication
(10) Pub. No.: US 2019/0197890 A1
(43) Pub. Date: Jun. 27, 2019

(54) METHODS, SYSTEMS, AND DRONES FOR ASSISTING COMMUNICATION BETWEEN A ROAD VEHICLE AND OTHER ROAD USERS

(71) Applicant: GM GLOBAL TECHNOLOGY OPERATIONS LLC, Detroit, MI (US)

(72) Inventors: Jiang L. Du, Beaverton, OR (US); Peggy Wang, Shanghai (CN)

(73) Assignee: GM GLOBAL TECHNOLOGY OPERATIONS LLC, Detroit, MI (US)

(21) Appl. No.: 15/855,529

(22) Filed: Dec. 27, 2017

(51) Int. Cl. G08G 1/09; G08G 1/01; G08G 5/00; G06K 9/00; G06K 9/62; G06K 9/78; B64C 39/02; G05D 1/12; B64D 47/02

(52) U.S. Cl. CPC G08G 1/091; G08G 1/012; G08G 5/0078; G08G 1/0133; G06K 9/00651; G08G 1/0965; G06K 9/78; B64C 39/024; G05D 1/12; B64D 47/02; G06K 9/6202

(57) ABSTRACT

Methods, systems, and aerial drones for assisting communication between a primary road vehicle and other road users are provided. In an exemplary embodiment, a method for assisting communication between a primary road vehicle and other road users includes observing a situation. Further, the method includes directing an aerial drone to a second road user. Also, the method includes communicating information about the situation from the aerial drone to the second road user.

### INTRODUCTION

Road vehicles, such as automotive vehicles, are generally limited to the confines of the roadway on which they are traveling. While the vehicle may be provided with a global position system (GPS) providing information about the roadway ahead, the road vehicle is typically limited in knowledge regarding more immediate situations. This is true of road vehicles driven by a user, i.e., driver, or in an autonomous driving mode.

For example, a road vehicle typically does not have advance knowledge of conditions on the roadway ahead such as aggressive drivers, disabled vehicles (including automobiles, motorcycles and bicycles), unsafe or non-conforming vehicles (such as a vehicle with an opened door, trunk, gas tank door, electric charge door, or the like), or unsafe pedestrians in or around the roadway.

It is desirable to provide the capability to observe a situation, such as an ongoing condition or an event, occurring in the roadway in the road vehicle's direction of travel but beyond the road vehicle's line of sight, whether the line of sight of a driver or of a vehicle-mounted sensor, such as camera, radar or lidar unit. Such capability may be provided by an aerial drone associated with the road vehicle. Further, it may be desirable to communicate images of the observed situation to the road vehicle for review by a driver or processor in the road vehicle.

Whether observed by the driver or vehicle mounted camera unit or observed by an aerial drone mounted camera unit, it is desirable to provide the capability to communicate to a second road user about the observed situation.

Accordingly, it is desirable to provide methods and systems for assisting communication between a primary road vehicle and other road users. Further, it is desirable to provide aerial drones that are associated with vehicles to communicate to other road users about observed situations. Furthermore, other desirable features and characteristics will become apparent from the subsequent detailed description and the appended claims, taken in conjunction with the accompanying drawings and the introduction.

### SUMMARY

Methods, systems, and aerial drones for assisting communication between a primary road vehicle and other road users are provided. In an exemplary embodiment, a method for assisting communication between a primary road vehicle and other road users includes observing a situation. Further, the method includes directing an aerial drone to a second road user. Also, the method includes communicating information about the situation from the aerial drone to the second road user.

In an exemplary embodiment of the method, observing the situation includes capturing images with the aerial drone and comparing the images with pre-defined events in a processor onboard the aerial drone to identify the situation. Further, in such embodiment, directing the aerial drone to the second road user may include utilizing an object tracking onboard the aerial drone. In such an embodiment, directing the aerial drone to the second road user may include communicating the situation to a primary user in the primary road vehicle, designating a second road user by the primary user in the primary road vehicle, communicating information about the second road user to the aerial drone, and targeting the second user with the aerial drone based on the information.

In an exemplary embodiment of the method, observing the situation includes capturing images with the aerial drone, communicating the images from the aerial drone to a processor onboard the primary road vehicle, and comparing the images with pre-defined events in the processor to identify the situation. In such an embodiment, directing the aerial drone to the second road user may include sending a command from the processor onboard the primary road vehicle to the aerial drone. Also, in such an embodiment, directing the aerial drone to the second road user may include communicating the situation to a primary user in the primary road vehicle, designating a second road user by the primary user in the primary road vehicle, communicating information about the second road user to the aerial drone, and targeting the second user with the aerial drone based on the information.

In an exemplary embodiment of the method, observing the situation may include capturing images with the aerial drone, communicating the images from the aerial drone to the primary road vehicle, and reviewing the images by a primary user in the primary road vehicle. In such embodiment, directing the aerial drone to the second road user may include the primary user issuing a command from the primary road vehicle to the aerial drone. In such embodiment, directing the aerial drone to the second road user may include designating a second road user by the primary user in the primary road vehicle, communicating information about the second road user to the aerial drone, and targeting the second user with the aerial drone based on the information.

In an exemplary embodiment of the method, observing the situation includes observing the situation by a primary user in the primary road vehicle, i.e., directly by the primary user. In such an embodiment, directing the aerial drone to the second road user may include the primary user issuing a command from the primary road vehicle to the aerial drone. Also, in such an embodiment, directing the aerial drone to the second road user may include designating a second road user by the primary user in the primary road vehicle, communicating information about the second road user to the aerial drone, and targeting the second user with the aerial drone based on the information.

In exemplary embodiments of the method, communicating information about the situation from the aerial drone to the second road user includes visually displaying text to the second road user, visually displaying video to the second road user, or transmitting an audio alert to the second road user.

In another embodiment, a system is provided for assisting communication between a primary road vehicle and other road users. The system for assisting communication between a primary road vehicle and other road users includes an aerial drone, a transmitter/transceiver link between the aerial drone and the primary road vehicle, and a communication device on the aerial drone for communicating a message to a second road user.

In exemplary embodiments of the system, the system further includes an image recording device associated with the aerial drone for observing a situation and capturing images of the situation. Also, in exemplary embodiments of the system, the system further includes a processor adapted to compare the images with pre-defined events to identify the situation. Further, in exemplary embodiments of the system, the system further includes a primary video display unit to display the images of the situation to a primary user of the primary road vehicle. In certain exemplary embodiments of the system, the communication device on the aerial drone comprises a secondary video display for visually communicating the message to the second road user.

Another embodiment provides an aerial drone for assisting communication between a primary road vehicle and other road users. The aerial drone includes a vehicle-to-everything (V2X) communication module for communicating with the primary road vehicle. Also, the aerial drone includes a video display for displaying a message to a second road user.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The present subject matter will hereinafter be described in conjunction with the following drawing figures, wherein like numerals denote like elements, and wherein:

FIG. 1 is a schematic representation of an exemplary embodiment of a road vehicle on a roadway and a deployed aerial drone in accordance with embodiments herein;

FIG. 2 is a schematic view of the aerial drone of FIG. 1 in accordance with embodiments herein;

FIG. 3 is a flow chart illustrating embodiments of a method for assisting communication between a primary road vehicle and other road users; and

FIG. 4 is a flow chart illustrating another embodiment of a method for assisting communication between a primary road vehicle and other road users.

### DETAILED DESCRIPTION

The following detailed description is merely illustrative in nature and is not intended to limit the embodiments of methods and systems for assisting operation of a road vehicle with an aerial drone. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Embodiments herein may be described below with reference to schematic or flowchart illustrations of methods, systems, devices, or apparatus that may employ programming and computer program products. It will be understood that blocks, and combinations of blocks, of the schematic or flowchart illustrations, can be implemented by programming instructions, including computer program instructions. These computer program instructions may be loaded onto a computer or other programmable data processing apparatus (such as a controller, microcontroller, or processor) to produce a machine, such that the instructions which execute on the computer or other programmable data processing apparatus create instructions for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks. Programming instructions may also be stored in and/or implemented via electronic circuitry, including integrated circuits (ICs) and Application Specific Integrated Circuits (ASICs) used in conjunction with sensor devices, apparatuses, and systems.

Embodiments herein provide for assisting communication between a primary road vehicle and other road users. Effectively, the methods, systems, and aerial drones described herein may provide for or support a social network of road users.

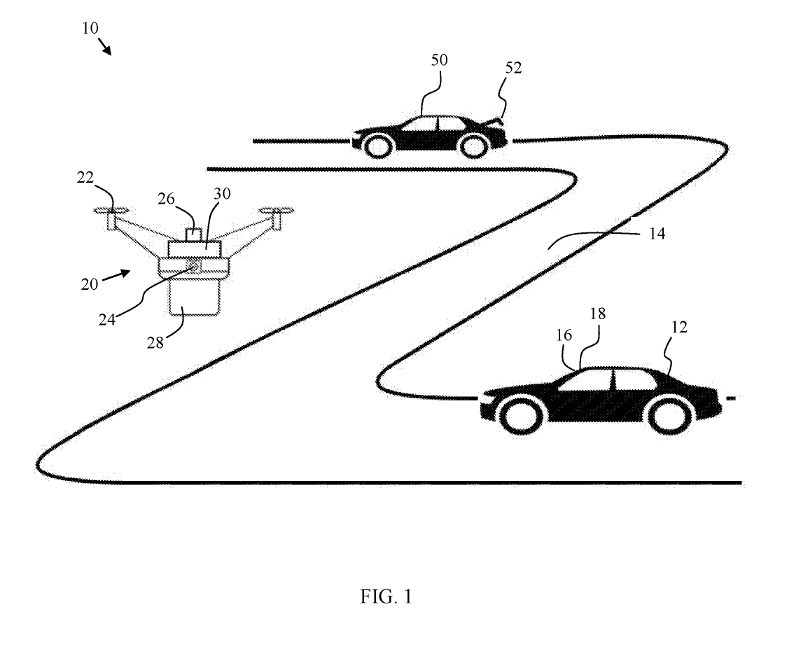

FIG. 1 is a schematic representation of an exemplary embodiment of a system 10 for assisting communication between a primary road vehicle and other road users. In FIG. 1, the system 10 includes a primary road vehicle 12 that is shown traveling on a roadway 14. While the primary road vehicle 12 is illustrated as being a car, any suitable road vehicle may be provided.

As shown, the primary road vehicle 12 is associated with and in communication with an aerial drone 20 through a transmitter/receiver, i.e., transceiver 16, located on the primary road vehicle 12. The exemplary primary road vehicle 12 also includes a processor/control unit 18.

An exemplary aerial drone 20 may be an unmanned quadrotor helicopter (“quadcoptor”) that is lifted and propelled by four rotors 22. An exemplary aerial drone 20 is paired with the primary road vehicle 12 to communicate information to and receive information from the primary road vehicle 12. Specifically, the exemplary aerial drone 20 includes a transceiver 26 for communicating with the transceiver 16 on the primary road vehicle 12.

As further shown, the aerial drone 20 includes an image capture or camera unit 24 for observing the roadway 14, recording video and/or capturing images thereof. An exemplary camera unit 24 may be a camera, a color sensitive light sensor, or a photosensor (such as a charge coupled device array as commonly found in digital cameras).

The exemplary aerial drone 20 further includes a visual display unit 28. For example, the display unit 28 may be a foldable, flexible or articulating screen. An exemplary display unit 28 includes a liquid-crystal display (LCD), a light-emitting diode (LED) based video display, or another electronically modulated optical device. The display unit 28 may be mounted on the bottom, top, or side of the aerial drone 20. Further, the display unit 28 may be movable from a stored position to a use position, such as by opening, unfolding and/or articulating. The display unit 28 may be deployed automatically or may deploy upon command from the primary road vehicle 12. The exemplary aerial drone 20 also includes a processor/controller unit 30. The processor/controller unit 30 may include additional sensors, such as a global positioning system (GPS), an ultrasonic sensor and/or accelerometer to map positions of the aerial drone 20 and the primary road vehicle 12. The sensors provide location data such as a position of the aerial drone 20 relative to the primary road vehicle 12 and the roadway 14.

The primary road vehicle 12 may be provided with a launch and landing pad for the aerial drone 20, such that the aerial drone 20 may be selectively launched or deployed from the primary road vehicle 20 as desired. For example, a user of the primary road vehicle 12 may direct launch and use of the aerial drone 20. The user may send an instruction through actuating a button or screen selection disposed within the vehicle cabin or on a key fob. The controller 18 receives a signal indicative of a user request to launch the aerial drone 20. Alternatively, the processor/control unit 18 of the primary road vehicle may automatically direct launch and flight of the aerial drone 20 via communication between the transceivers 16 and 26.

FIG. 1 further illustrates a second road user 50 on the roadway 14. In the illustrated embodiment, the second road user 50 is a second vehicle, though the second road user may be any other type of road user. In the embodiment of FIG. 1, the trunk of the second vehicle is opened. The open trunk may constitute a situation that can be identified by the system 10 and resolved by communication with the second road user 50. As can be seen in FIG. 1, the layout of the roadway 14 would make direct viewing of the open trunk of the second vehicle difficult for a driver or passenger in the primary road vehicle 12. However, the aerial drone 20 is able to move more freely, without restriction to the path of the roadway, and may capture images of the open trunk for use as described below. Therefore, the aerial drone 20 provides an advantageous view as compared to the primary road vehicle 12.

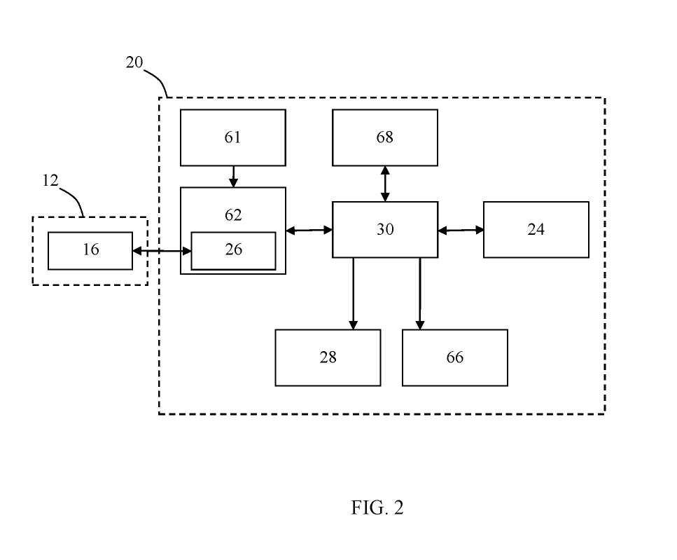

FIG. 2 is a schematic illustration of the exemplary aerial drone 20 of FIG. 1. In FIG. 2, the aerial drone 20 includes the processor 30 interconnected with the camera 24, the transceiver 26, and the display unit 28, as previously illustrated in FIG. 1. As shown, the transceiver 26 is adapted for communication to and from the transceiver 16 mounted on the primary road vehicle 12.

In FIG. 2, the transceiver 26 is shown as being part of a communications module 62, such as a V2X communications module. An exemplary transceiver 26 is a dual RF transceiver. The communications module 62 may further include an antenna or connectivity unit. While shown as an independent entity, the communications module 62 may be considered to be part of the processor 30. As further shown, the aerial drone 20 further includes a location device 61, such as a global positioning system (GPS) and a compass. The location device 61 is connected to the communications module 62 to transmit location information, such as position, orientation, and direction of travel to the communications module 62.

The processor 30 may further include autopilot software for controlling flight of the aerial drone 20. Also, the processor 30 may include a display control module for controlling the display unit 28 and a camera control module for controlling the camera 24. As shown, the aerial drone 20 may further include a speaker unit 66 for audio transmission of information directly from the aerial drone 20. The processor 30 may include an audio control module for controlling the speaker 66. The aerial drone may also include a lighting unit 68. An exemplary lighting unit 68 includes a light sensor and a lamp for emitting light. The processor 30 may include a light control module for controlling the lighting unit 68.

While communication from the primary road vehicle 12 to the aerial drone 20 is provided between transceivers 16 and 26, in other embodiments, a network, such as a wife or Bluetooth network may be provided to enable direct communication from the vehicle processor 18 and the processor 30 of the aerial drone 20. Network communication may be particularly suitable for transferring images and video.

While not illustrated, the aerial drone 20 may include other components. For example, the aerial drone 20 will include a power source, such as a battery, for powering the rotors, camera 24, display unit 28, speaker 66, location device 61, lighting unit 68 and computer processing and modules.

As illustrated in FIG. 2, the aerial drone 20 is provided for automated flight control, image recording, and transmission of images to the primary road vehicle 12. For example, a user in primary road vehicle 12 may activate or direct flight of the aerial drone 20 via a communication from the transceiver 16 or a network to the aerial drone processor 30. The aerial drone processor 30 may control the rotors 22 to launch the aerial drone 20 from the primary road vehicle 12 and to control flight thereafter. Information from the location device 61 is used by the aerial drone processor 30 to navigate to a desired location ahead of the primary road vehicle 12. Communication with the primary road vehicle 12 allows the aerial drone 20 to maintain a suitable distance ahead of the primary road vehicle 12 along the roadway. The communications module 62 on the aerial drone 20 provides for communication with the primary road vehicle to obtain the speed and direction of travel of the primary road vehicle. Further, the communications module 62 may provide for communication with infrastructure via a road side unit (RSU). For example, the aerial drone 20 or the road vehicle 12 can communicate through V2X with infrastructure such as traffic lights and other road side units that also have V2X capability. The RSU can in turn broadcast the information to other users or vehicles within certain distance with range of the RSU.

In certain embodiments, the primary road vehicle may not be provide with V2X communication capabilities while the aerial drone is capable of V2X communication. In such embodiments, the aerial drone may communicate with other road users or with infrastructure and then transfer information to the primary road vehicle in another format.

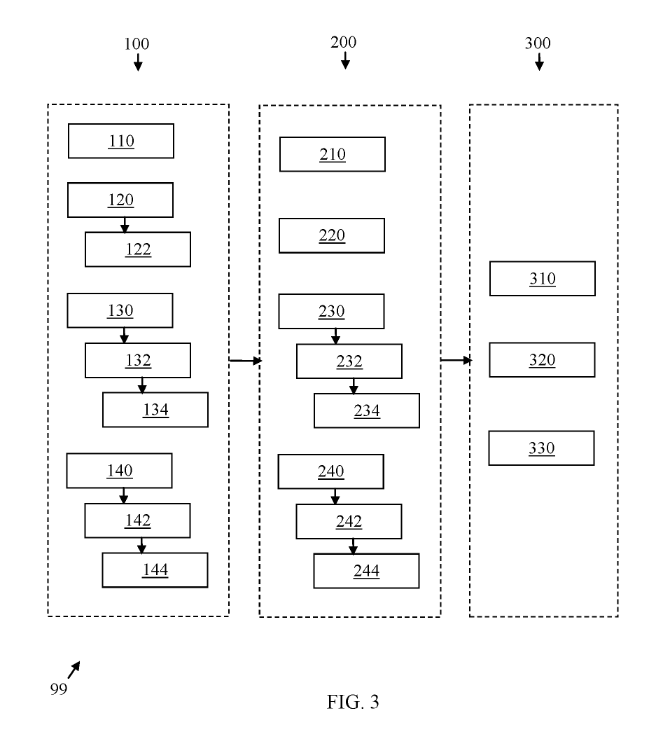

FIG. 3 illustrates various embodiments of a method 99 for assisting communication between a primary road vehicle and other road users, such as other automobiles, motorcycles, bicycles, pedestrians, or other potential road users. In FIG. 3, the illustrated method 99 includes observing a situation at action block 100. After observing a situation, the method 99 includes directing an aerial drone to a second road user at action block 200. Further, after directing the aerial drone to the second road user, the method 99 includes communicating information about the situation from the aerial drone to the second road user at action block 300.

As used herein, the situation that is observed may be an action or condition that is pre-determined or pre-classified as being of interest, and identified through an automated process performed by a processor. Alternatively, the situation that is observed may be identified in real time without prior classification, such as by a driver or other vehicle user. Further, the situation may be observed through a semi-automated process that also includes operator input.

The situation that is observed may be an action or condition that is dangerous or hazardous, a nuisance, or merely unexpected. For example, the situation may be a disabled vehicle (including automobiles, motorcycles and bicycles), unsafe or non-conforming vehicles (such as a vehicle with an opened door, trunk, gas tank door, electric charge door, or the like), or unsafe pedestrians in or around the roadway. Further, the situation may be another road user performing aggressive road maneuvers, e.g., an aggressive driver.

As shown in FIG. 3, in certain embodiments, the action of observing the situation 100 may be performed at action block 110 by a primary user in the primary road vehicle, such as a driver or other vehicle occupant, directly observing the situation.

Alternatively, the action of observing the situation 100 may be performed at action block 120 by capturing images with the aerial drone. The method continues at action block 122 by comparing the captured images with pre-defined events in a processor onboard the aerial drone to identify the situation. For example, the exemplary processor includes an algorithm, which can be machine learning based and/or rule based. The processor will automatically recognize the images which correspond to images of pre-defined events and hence identify the situation. One way to achieve this is to use techniques of machine learning (e.g., supervised learning) and image processing. The pre-defined events are represented by a set of training examples, such as images of trunk-open. A certain machine learning algorithm analyzes the training examples and identifies or produces the inferred event, which will be used to compare the new images captured by the aerial drone.

At action block 130, the action of observing the situation 100 also may be performed by capturing images with the aerial drone. However, the method continues at action block 132 by communicating the captured images from the aerial drone to a processor onboard the primary road vehicle. At action block 134, the processor compares the images with pre-defined events in the processor to identify the situation.

In a semi-automated/semi-operator driven process, at action block 140, the action of observing the situation 100 is again performed by capturing images with the aerial drone and the method continues at action block 142 by communicating the captured images from the aerial drone to a processor onboard the primary road vehicle. At action block 144, a primary user in the primary road vehicle reviews the images to identify the situation. For example, the processor onboard the primary road vehicle may present the capture images for review by the primary user in the primary road vehicle, such as on a head up display (HUD), a center stack screen, or another visual display within the primary road vehicle.

After the presence of a situation is identified in action block 100, method 99 continues with directing the aerial drone to a second road user at action block 200. In certain cases, the second road user is the observed situation, or is the cause of the observed situation. For example, an improperly hitched trailer may be attached to the second road user's vehicle. In other cases, the second road user may be another party with no connection to the observed situation. For example, the second road user may be an automobile traveling near the primary road user, and the observed situation may be an aggressive driver one-half mile ahead.

The action of directing the aerial drone to the second road user 200 may include utilizing an object tracking system onboard the aerial drone at action block 210. Alternatively, the action of directing the aerial drone to the second road user 200 may be performed by the primary user or an onboard processor issuing a command from the primary road vehicle to the aerial drone at action block 220.

Alternatively, the action of directing the aerial drone to the second road user 200 may include communicating the situation to a primary user in the primary road vehicle at action block 230. The primary user may designate a second road user at action block 232 and information about the second road user, e.g., license plate number, location relative to primary road vehicle, may be communicated to the aerial drone. At action block 234, the aerial drone targets the second user based on the information.

After directing the aerial drone to the second road user at action block 200, the method includes communicating information about the situation from the aerial drone to the second road user at action block 300. In certain embodiments, the aerial drone may travel alongside or hover near the second road user. In other embodiments, the aerial drone may land on the second road user.

At action block 310 the aerial drone visually displays text to the second road user. For example, the aerial drone may display a message such as “CHECK TRAILER” to the second road user. Alternatively, the aerial drone visually displays video to the second road user at action block 320. For example, the aerial drone may display still or moving images of the observed situation. Alternatively or additionally, the aerial drone transmits an audio alert to the second road user at action block 330.

As illustrated in FIG. 3, multiple embodiments of a method 99 for assisting communication between a primary road vehicle and other road users are provided. In certain embodiments, the aerial drone captures images with a camera and an embedded processor on the aerial drone performs image processing and recognition based on pre-defined events or conditions. In other embodiments, the aerial drone communicates the captured images to a processor onboard the primary road vehicle for image processing and recognition. In other embodiments, a user of the primary road vehicle detects the situation without processor recognition. In such embodiments, the user may view the situation directly, i.e., without a presentation of the image on a display unit or screen, or indirectly, i.e., via a presentation on a display unit or screen of images captured by the aerial drone.

Further, after observation of (and recognition of) a situation, the aerial drone flies to and targets the second road user. In certain embodiments, the aerial drone includes embedded object tracking and following functionality such that the aerial drone may target the second road user itself. In other embodiments, a user in the primary road vehicle may designate a remote road user as the second road user and use the aerial drone to target the second road user. For example, the user in the primary road vehicle may designate and target the second road user based on V2X message, including information such as a vehicle license plate, a vehicle model, or other descriptive information.

After the aerial drone flies to the second road user, information about the situation is communicated from the aerial drone to the second road user. For example, the aerial drone may visually display a warning message about the situation, an image of the situation, and/or a video of an event. Alternatively or additionally, the aerial drone may transmit an audio message, such as a recorded audio message or a message generated by text to speech (TTS).

In certain applications, information is communicated from the aerial drone to a single other road user. In other applications, a plurality of other road users may be targeted and communicated with by the aerial drone. In such embodiments, the aerial drone may broadcast information through visual display and/or audio speakers. Also, the aerial drone may communicate with a plurality of other road users through V2X communication. For example, the primary road vehicle may communicate the message to the aerial drone via V2X communication, and the aerial drone may then communication the message to other road users via V2X communication. If applicable, the second road user may receive the V2X communication and present it through a visual display of the vehicle or an audio message transmitted by the vehicle speaker system.

It is also contemplated that the second road user may be outfitted for two way communication with the aerial drone. For example, the second road user may include a processor and transceiver capable of communicating with the processor and transceiver onboard the aerial drone. Further, the second road user may have an aerial drone landing pad to facilitate communication with the aerial drone. As a result, the second road user may communicate information in the form of text messages, captured images, video, and the like to the primary road vehicle via the aerial drone. Such communication may occur via a wireless transceiver to transceiver transmission, or through a wired connection if the aerial drone is received on the landing pad.

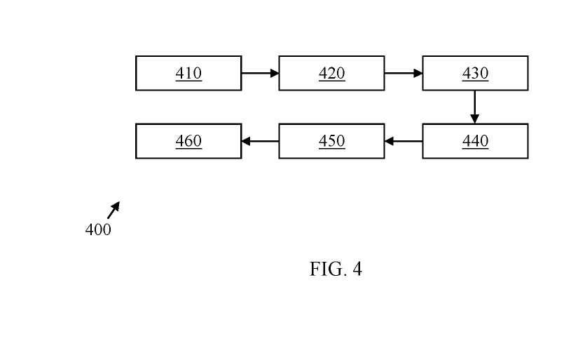

FIG. 4 illustrates an embodiment of a method 400 for assisting communication between a primary road vehicle and other road users, such as other automobiles, motorcycles, bicycles, pedestrians, or other potential road users. In FIG. 4, the illustrated method 400 includes a driver or user of the primary road vehicle initiating a request to communicate with another road user at action block 410. For example, the request can be made through a voice command or command input at the primary road vehicle processor. The request is then communicated from the primary road vehicle to the aerial drone in the form of a V2X communication.

At action block 420, the aerial drone broadcasts the request to surrounding road users. For example, the aerial drone may communicate the request to the other road users via a V2X communication.

At action block 430, a select road user accepts the request from the aerial drone by sending an acceptance communication to the aerial drone. Included in each acceptance communication is identification information associated with the other road user, e.g., a license plate number, vehicle brand and model, vehicle appearance, road user location, and the like. The aerial drone forwards the acceptance communication to the primary road vehicle.

At action block 440, the aerial drone determines the location of the select road user by location device, such as by GPS, or by the vehicle identification information included in the acceptance communication, and identifies the select road user. At action block 450, the aerial drone flies to and lands on a landing pad of the select road user. Upon landing, a wired connection may be formed between the aerial drone and the select road user. Alternatively, a wireless connection may be used for communication. At action block 460, the aerial drone transmits information, such as streaming video, images, or messages between the primary road vehicle and the select road user.

As described herein, methods, systems, and aerial drones for assisting communication between a primary road vehicle and other road users are provided. The methods and systems utilize an aerial drone to extend the communication range of a primary road vehicle. Further, the aerial drone provides an increased viewing range of potential issues for the primary road vehicle

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the claimed subject matter in any way. Rather, the foregoing detailed description will provide those skilled in the art with a convenient road map for implementing an exemplary aspect of the subject matter. It being understood that various changes may be made in the function and arrangement of elements described in an exemplary aspect without departing from the scope of the subject matter as set forth in the appended claims.

What is claimed is:

1. A method for assisting communication between a primary road vehicle and other road users, the method comprising:
observing a situation;
directing an aerial drone to a second road user; and
communicating information about the situation from the aerial drone to the second road user.

2. The method of claim 1 wherein observing the situation comprises:
capturing images with the aerial drone; and
comparing the images with pre-defined events in a processor onboard the aerial drone to identify the situation.

3. The method of claim 2 wherein directing the aerial drone to the second road user comprises utilizing an object tracking onboard the aerial drone.

4. The method of claim 2 wherein directing the aerial drone to the second road user comprises:
communicating the situation to a primary user in the primary road vehicle;
designating a second road user by the primary user in the primary road vehicle;
communicating information about the second road user to the aerial drone; and
targeting the second road user with the aerial drone based on the information.

5. The method of claim 1 wherein observing the situation comprises:
capturing images with the aerial drone;
communicating the images from the aerial drone to a processor onboard the primary road vehicle; and
comparing the images with pre-defined events in the processor to identify the situation.

6. The method of claim 5 wherein directing the aerial drone to the second road user comprises sending a command from the processor onboard the primary road vehicle to the aerial drone.

7. The method of claim 5 wherein directing the aerial drone to the second road user comprises:
communicating the situation to a primary user in the primary road vehicle;
designating a second road user by the primary user in the primary road vehicle;
communicating information about the second road user to the aerial drone; and
targeting the second road user with the aerial drone based on the information.

8. The method of claim 1 wherein observing the situation comprises:
capturing images with the aerial drone;
communicating the images from the aerial drone to the primary road vehicle; and
reviewing the images by a primary user in the primary road vehicle.

9. The method of claim 8 wherein directing the aerial drone to the second road user comprises the primary user issuing a command from the primary road vehicle to the aerial drone.

10. The method of claim 8 wherein directing the aerial drone to the second road user comprises:
designating a second road user by the primary user in the primary road vehicle;
communicating information about the second road user to the aerial drone; and
targeting the second road user with the aerial drone based on the information.

11. The method of claim 1 wherein observing the situation comprises observing the situation by a primary user in the primary road vehicle.

12. The method of claim 11 wherein directing the aerial drone to the second road user comprises the primary user issuing a command from the primary road vehicle to the aerial drone.

13. The method of claim 11 wherein directing the aerial drone to the second road user comprises:
designating a second road user by the primary user in the primary road vehicle;
communicating information about the second road user to the aerial drone; and
targeting the second road user with the aerial drone based on the information.

14. The method of claim 1 wherein communicating information about the situation from the aerial drone to the second road user comprises visually displaying text to the second road user, visually displaying video to the second road user, or transmitting an audio alert to the second road user.

15. A system for assisting communication between a primary road vehicle and other road users, the system comprising:
an aerial drone;
a transmitter/transceiver link between the aerial drone and the primary road vehicle; and
a communication device on the aerial drone for communicating a message to a second road user.

16. The system of claim 15 further comprising an image recording device associated with the aerial drone for observing a situation and capturing images of the situation.

17. The system of claim 16 further comprising a processor adapted to compare the images with pre-defined events to identify the situation.

18. The system of claim 16 further comprising a primary video display unit to display the images of the situation to a primary user of the primary road vehicle.

19. The system of claim 15 wherein the communication device on the aerial drone comprises a secondary video display for visually communicating the message to the second road user.

20. An aerial drone for assisting communication between a primary road vehicle and other road users, the aerial drone comprising:
a vehicle-to-everything (V2X) communication module for communicating with the primary road vehicle; and
a video display for displaying a message to a second road user.
